(19) United States
(12) Patent Application Publication
(10) Pub. No.: US 2009/0148630 A1
(43) Pub. Date: Jun. 11, 2009

(54) DISPLAY ASSEMBLY OF FOLDED ROLLED PAPER PRODUCTS

(76) Inventors: Noel Mathey Geoffroy, Cincinnati, OH (US); Rachael Eden Walther, Union, KY (US); Connie Marie Roetker, Fairfield, OH (US); Paul Francis O'Conner, Portland, OR (US); William Travis Lonigan, Beaverton, OR (US); Heather Sabrina Cummings, Portland, OR (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/328,171

(22) Filed: Dec. 4, 2008

Related U.S. Application Data
(60) Provisional application No. 60/992,731, filed on Dec. 6, 2007.

(51) Int. Cl. B32B 1/04

(52) U.S. Cl. 428/14

(57) ABSTRACT

A display assembly with a plurality of rolled paper products having: a plurality of folded implements convolutely wound about a core or a void area, capable of being dispensed from the rolled paper product, comprising a fibrous structure having a first flap with a first edge; a second flap with a second edge; and a body, between the first flap and the second flap, the body having a first surface and a second surface; wherein the first flap and the second flap are folded against and overlap either the first surface or the second surface of the body.

### CROSS-REFERENCE TO RELATED APPLICATION

This application claims the benefit of provisional U.S. Application No. 60/992,731, filed Dec. 6, 2007.

### FIELD OF THE INVENTION

The present invention relates to folded absorbent paper products in roll form, more particularly, folded absorbent paper products in roll form that are provided in a display assembly.

### BACKGROUND OF THE INVENTION

Consumers of absorbent paper products, such as paper towels or toilet paper, may use different types of products for different tasks. For example, a consumer may use the Bounty® Extra Soft product to clean fragile or delicate surfaces, Bounty® Shop Towel for tough jobs, and Bounty® for every day use in the kitchen. Many consumers keep only one product in a particular location at a any given time, but may require a different product from the one in that particular location (i.e., Bounty® Shop Towel may be needed in the kitchen, but is kept in the garage), requiring the consumer to go from one location to another to retrieve the different product, which may cause inefficiencies detrimental to the consumer's overall usage experience.

C-, V- and/or Z-folded fibrous structures are known in the art especially for facial tissues and/or napkins. These folded products provide a variety of consumer benefits. Further, these folded fibrous structures may also be provided in roll form. However, these products often do not fit into standard size roll dispensers. Thus many consumers desire folded rolled paper products that are compatible with existing holders or dispensers that are standard sizes.

Accordingly, there is a need for a folded absorbent paper product in roll form that exhibits improved functional and aesthetic benefits to the consumer. Consumers desire the functional benefits and convenience resulting from a folded, rolled absorbent paper product wherein the product is provided in sizes that are compatible with many of the standard dispensing and storage devices that the consumer may already possess.

### SUMMARY OF THE INVENTION

In an embodiment the invention herein relates to a display assembly comprising: a plurality of rolled paper products comprising: a plurality of folded implements convolutely wound about a core or a void area, capable of being dispensed from the rolled paper product, comprising a fibrous structure having a first flap with a first edge; a second flap with a second edge; and a body, between the first flap and the second flap, the body having a first surface and a second surface; wherein the first flap and the second flap are folded against and overlap either the first surface or the second surface of the body.

### BRIEF DESCRIPTION OF THE DRAWINGS

FIG. 1A is a perspective representation of an implement according to the present invention;

FIG. 1B is a perspective representation of the implement of FIG. 1 in its unfolded state;

FIG. 2 is a cross-sectional view of the implement of FIG. 1 taken along line 2-2;

FIG. 3 is a perspective representation of another product implement according to the present invention;

FIG. 4 is a cross-sectional view of the implement of FIG. 3 taken along line 4-4;

FIG. 5 is a planar view of another implement according to the present invention;

FIG. 6 is a planar view of another implement according to the present invention;

FIG. 7 is a planar view of another implement according to the present invention;

FIG. 8 is a perspective view of another implement according to the present invention;

FIG. 9 is a perspective view of the implement of FIG. 1A in roll form;

FIG. 10 is a perspective view of another implement according to the present invention;

FIG. 11 is a perspective view of a display assembly of rolled paper products comprising implements of FIG. 9;

FIG. 12 is a front view of a holder housing rolled paper products according to the present invention.

### DETAILED DESCRIPTION OF THE INVENTION

### Definitions

“Implement”, as used herein, means a sheet or single or discrete sheet of an absorbent paper product comprising a fibrous structure and having dimensions that are suitable for use by a consumer for its intended purpose. In another embodiment, a plurality of an absorbent paper product implements may be provided in roll form. In one example, the implement is a continuous sheet that comprises lines of weakness, such as in the cross machined direction such that individual sheets of fibrous structure (for example, paper towel implements) may be dispensed from a rolled absorbent paper product. In one embodiment, the implement is provided in folded form and a plurality of folded implements is provided in rolled form. The implement may comprise toilet tissue, paper towels, facial tissue, and the like.

“Fibrous structure”, as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process. The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps; mechanical pulps including groundwood, thermomechanical pulp; chemithermomechanical pulp; chemically modified pulps, and the like. Chemical pulps in an embodiment are useful herein to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from non-wood pulp such as cotton linters, bagesse, and the like, can be used. Additionally, fibers derived from recycled paper, which may contain any or all of the pulp categories listed above, as well as other non-fibrous materials such as fillers and adhesives used to manufacture the original paper product may be used in the present fibrous structures. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, lyocel, polyester, polyethylene, and polypropylene fibers can be used within the scope of the present invention. Further, such fibers may be latex bonded. Other materials are also intended to be within the scope of the present invention as long as they do not interfere or counter act any advantage presented by the instant invention.

“Fibrous structure”, as used herein, means a structure that may comprise one or more fibers. Nonlimiting examples of processes for making fibrous structures include known wet-laid papermaking processes and air-laid papermaking processes. Such processes typically include steps of preparing a fiber composition, oftentimes referred to as a fiber slurry in wet-laid processes, either wet or dry, and then depositing a plurality of fibers onto a forming wire or belt such that an embryonic fibrous structure is formed, drying and/or bonding the fibers together such that a fibrous structure is formed, and/or further processing the fibrous structure such that a finished fibrous structure is formed. For example, in typical papermaking processes, the finished fibrous structure is the fibrous structure that is wound on the reel at the end of papermaking, but before converting thereof into a sanitary tissue product.

“Basis Weight”, as used herein, is the weight per unit area of a sample of fibrous structure reported in lbs/3000 ft² or g/m².

“Machine Direction” or “MD”, as used herein, means the direction parallel to the flow of the absorbent paper product or fibrous structure through the papermaking machine and/or product manufacturing equipment.

“Cross Machine Direction” or “CD”, as used herein, means the direction perpendicular to the machine direction in the same plane of the fibrous structure and/or absorbent paper product comprising the fibrous structure.

In one embodiment, the fibrous structure may be manufactured via a wet-laid paper making process. In other embodiments, the fibrous structure may be manufactured via a through-air-dried paper making process or foreshortened by creping or by wet microcontraction. In some embodiments, the resultant fibrous structure plies may be differential density fibrous structure plies, wet laid fibrous structure plies, air laid fibrous structure plies, conventional fibrous structure plies, and combinations thereof. Creping and/or wet microcontraction are disclosed in U.S. Pat. Nos. 6,048,938, 5,942,085, 5,865,950, 4,440,597, 4,191,756, and 6,187,138.

Non-limiting types of fibrous structures according to the present invention include conventionally felt-pressed fibrous structures; pattern densified fibrous structures; and high-bulk, uncompacted fibrous structures. The fibrous structures may be of a homogenous or multilayered (two or three or more layers) construction; and the sanitary tissue products made therefrom may be of a single-ply or multi-ply construction.

In one embodiment, the fibrous structure is in the form of a rolled paper product. For example, the fibrous structure may be convolutely wound about a core or a void area where a core would be present.

In one example, the fibrous structure of the present invention is a pattern densified fibrous structure characterized by having a relatively high-bulk region of relatively low fiber density and a display assembly of densified regions of relatively high fiber density. The high-bulk field is characterized as a field of pillow regions. The densified zones are referred to as knuckle regions. The knuckle regions exhibit greater density than the pillow regions. The densified zones may be discretely spaced within the high-bulk field or may be interconnected, either fully or partially, within the high-bulk field. In one embodiment, from about 8% to about 65% of the fibrous structure surface comprises densified knuckles, the knuckles may exhibit a relative density of at least 125% of the density of the high-bulk field. Processes for making pattern densified fibrous structures are well known in the art as exemplified in U.S. Pat. Nos. 3,301,746, 3,974,025, 4,191,609 and 4,637,859.

The finished fibrous structure may exhibit regions of higher density compared to other regions within the finished fibrous structure. In other words, the finished fibrous structure may comprise a differential density fibrous structure.

The finished fibrous structure may be creped or uncreped and/or foreshortened or not. The finished fibrous structure may be a through-air-dried fibrous structure, a wet-pressed fibrous structure and/or a conventionally dried fibrous structure.

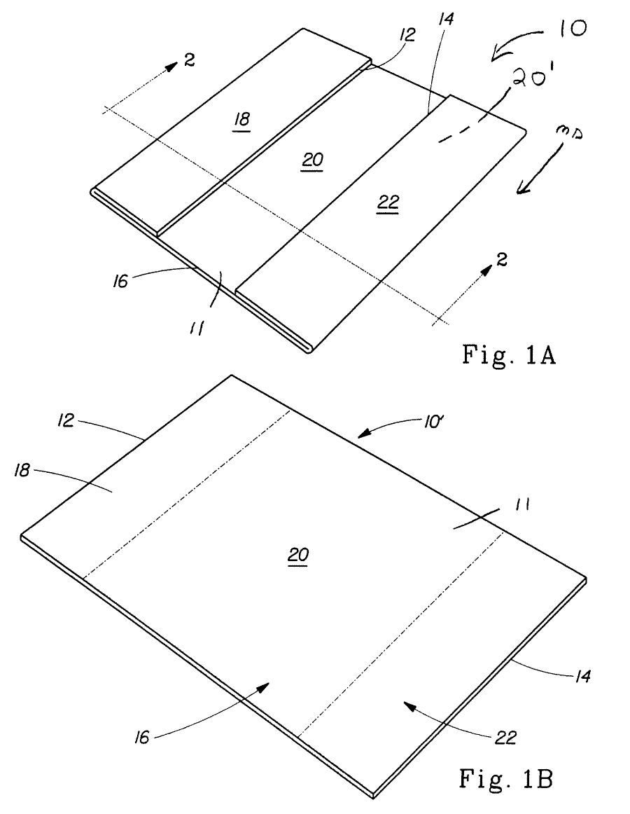

An exemplary embodiment of the present invention is shown in FIG. 1A, implement 10 comprises a fibrous structure 11 with a first edge 12 of implement 10, a second edge 14 of the implement 10 and a body 16. The body 16 has a first surface 20 and a second surface 20′. The first edge 12, via a first flap 18 may be folded against or overlap a first surface 20 of the body 16. A second flap 22 may be folded against, overlap or overlie the first surface 20 of the body 16. In FIG. 1A the first edge 12 and second edge 14 are complementary. In another embodiment, the first edge 12 and second edge 14 may be mismatched.

In an embodiment, the first flap 18 and/or second flap 22 may overlap less than about 100% and/or less than about 95% and/or less than about 90% and/or less than about 85% and/or less than about 80%, and/or overlap from about 5% to about 98%, and/or from about 10% to about 95%, of the surface area of the first surface 20 or the second surface 20′ of the body 16.

The first edge 12 and/or the second edge 14 may define a pattern (design element) include a complementary (e.g. mirror image), symmetrical pattern, etc. In one example, the pattern (design element) may comprise a shape. The shape may be selected from the group consisting of: hearts, circles, triangles, squares, rectangles, trapezoids and mixtures thereof. In another example, the pattern (design element) may comprise an element selected from the group consisting of: animals, plants, flowers and mixtures thereof.

FIG. 1B illustrates the implement 10 of FIG. 1A in its unfolded form 10′. The dashed lines on the body 16 of the implement represent lines of weakness or fold lines for the first and second flaps 18, 22.

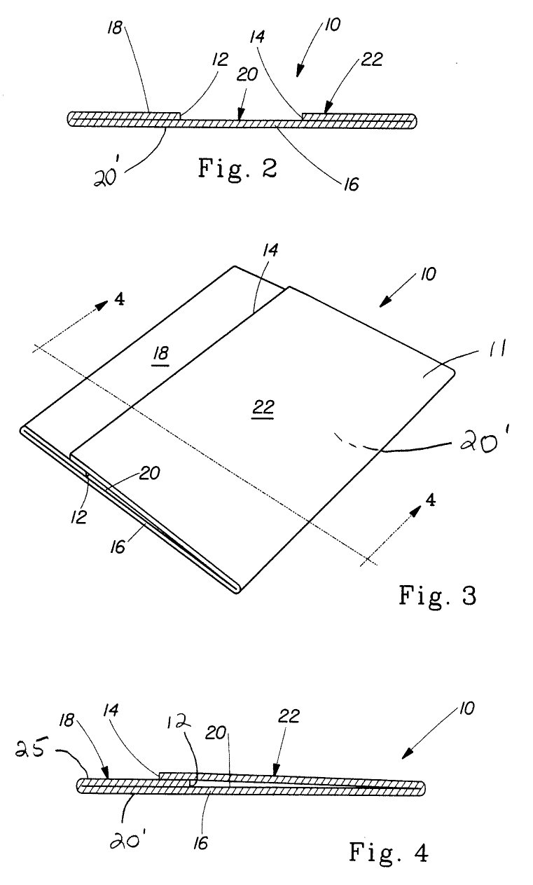

FIG. 2 is a cross-sectional view of the implement 10 of FIG. 1A. As shown in FIG. 2, the implement comprises two sections that are “multi-ply” and one section that is “single-ply.”

In one example, the “multi-ply” sections of the implement comprises a caliper of from about 75% and/or about 85% and/or about 95% to about 125%, and/or about 115%, and/or about 105%, or from about 85% to about 150%, of the caliper of the “single-ply” section.

In one example, the caliper in the cross-machine direction of the implement varies across the entire cross-machine direction. For example, the caliper in the cross-machine direction of the implement is controlled to vary along the entire cross-machine direction by less than about 2 times and/or less than about 1.5 times and/or less than about 1.25 times and/or less than about 1.15 times and/or less than about 1.05 times the least caliper of the implement along the entire cross-machine direction. By controlling the differential caliper across the cross-machine direction of the implement, the implement may be wound into a roll that exhibits an effective caliper that varies across the entire cross-machine direction of the rolled paper product implement by less than about 2 times and/or less than about 1.5 times and/or less than about 1.25 times and/or less than about 1.15 times and/or less than about 1.05 times the least caliper of the implement along the entire cross-machine direction.

Nonlimiting examples of processes useful in controlling the caliper of the implement in the cross-machine direction include imparting texture to portions of the fibrous structure such as by embossing, calendaring portions of the fibrous structure and/or adjusting the basis weight of portions of the fibrous structure.

As shown in FIGS. 3 and 4, an implement 10 comprises a fibrous structure 11 with a first edge 12 and a second edge 14 and a body 16. The body 16 has a first surface 20 and a second surface 20′. The first flap 18 may be folded against or overlap a first surface 20 of the body 16. A second flap 22 may be folded against, overlap at least some of the first surface 20 of the body 16. The second flap 22 overlaps some of the surface area of the first flap top surface 25. As shown in FIG. 3, the second edge 14 overlaps the first flap 18 as well as the first edge 12. The folded implement of FIG. 3 effectively comprises a “three-ply” section. This three-ply section is offset from the center of the implement. The implement 10 of FIG. 3 and 4 also comprises two sections that are “two-ply”. The multi-ply sections may thus be positioned where a consumer may need them for cleaning tasks, for example near the center of the fibrous structure implement.

As shown in FIG. 3, the second flap 22 may overlap less than about 100% and/or less than about 90% and/or less than about 75% and/or less than about 50% and/or less than about 30% and/or less than about 15%, or from about 15% to about 98%, of the surface area of the first flap top surface 25. FIG. 4 is a cross-section view of the implement of FIG. 3 taken along 4-4.

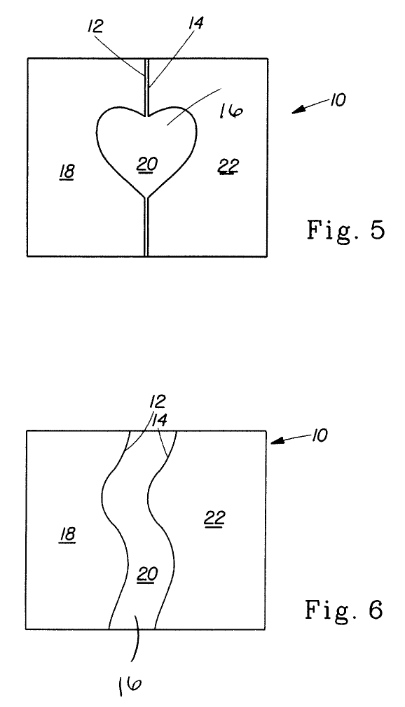

FIG. 5 illustrates an implement 10 that comprises a fibrous structure with a first edge 12 and a second edge 14, and a body 16 that has a first surface 20. The first flap 18 is folded against or overlaps the first surface 20 of the body 16. A second flap 22 is folded against and overlaps the first surface 20 of the body 16. The first edge 12 and the second edge 14 combine to form a mirror image pattern that forms a heart shaped pattern.

FIG. 6 illustrates an implement 10 that comprises a fibrous structure with a first edge 12 and a second edge 14, and a body 16 that has a first surface 20. The first flap 18 is folded against or overlaps the first surface 20 of the body 16. A second flap 22 is folded against and overlaps the first surface 20 of the body 16. The first edge 12 is nonlinear and the second edge 14 is nonlinear. The first edge 12 and the second edge 14 combine to form a symmetrical pattern.

In another example, the first edge 12 may be linear and the second edge 14 may be nonlinear. In another example, the first edge 12 may be nonlinear and the second edge 14 may be linear. In still another example, the first edge 12 may be linear and the second edge 14 may be linear.

Nonlimiting examples of nonlinear edges include sinusoidal edges, jagged edges, scalloped edges, angular edges, and dentil edges.

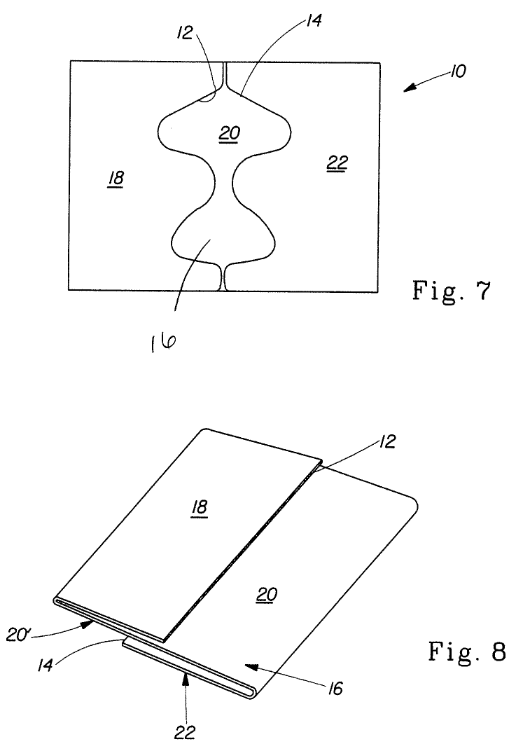

FIG. 7 illustrates another nonlimiting example that comprises an implement 10 of fibrous structure with a first edge 12 and a second edge 14, and a body 16 that has a first surface 20. The first flap 18 is folded against or overlaps the first surface 20 of the body 16. A second flap 22 is folded against and overlaps the first surface 20 of the body 16. The first edge 12 is nonlinear and the second edge 14 is nonlinear. The first edge 12 and the second edge 14 combine to form a mirror image pattern. In FIG. 7 the first edge 12 and second edge 14 are nonlinear and are complementary. In another embodiment, the first edge 12 and the second edge 14 are non-linear and are symmetrical.

FIG. 8 illustrates another example of an implement 10 according to the present invention wherein the first edge 12 and the first flap 18 overlaps the first surface 20 of the body 16 and the second edge 14 and the second flap 22 overlaps a second surface 20′ of the body 16.

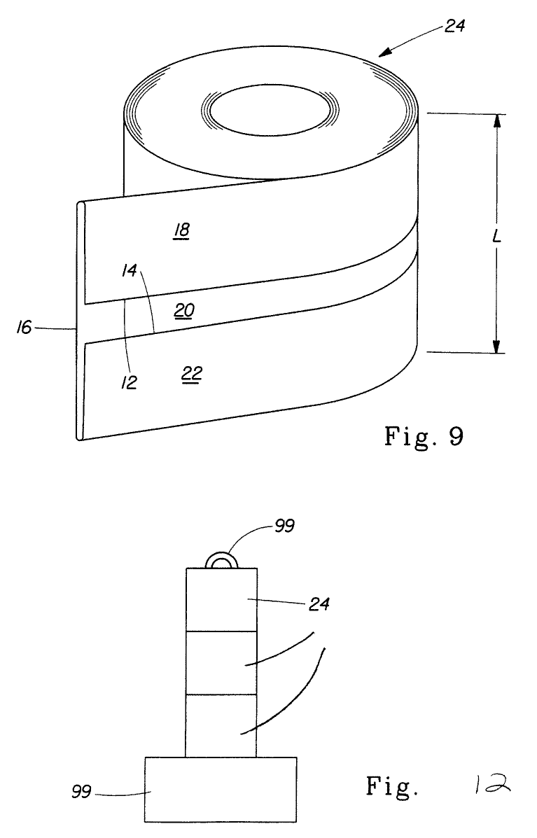

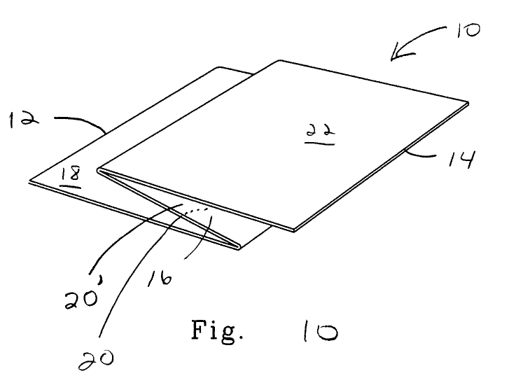

As shown in FIG. 9, an implement 10 comprises a fibrous structure with a first edge 12 and a second edge 14, and a body 16 that has a first surface 20. The first flap 18 is folded against or overlaps the first surface 20 of the body 16. A second flap 22 is folded against and overlaps the first surface 20 of the body 16. The first edge 12 and the second edge 14 are linear. The rolled paper product has a length L in the CD. In one embodiment herein the implement 10 may be continuous and may be convolutely wound to form a rolled paper product 24.

FIG. 10 illustrates another non-limiting example of an implement 10 comprises a fibrous structure with a first edge 12 and a second edge 14, and a body 16 that has a first surface 20 and a second surface 20′. The first flap 18 is folded against or overlaps the first surface 20 of the body 16. A second flap 22 is folded against and overlaps the second surface 20′ of the body 16. The first edge 12 and the second edge 14 are linear.

Typical absorbent paper products in roll form, such as paper towel products sold in the market, have a length, L, of about 9 inches to about 11 inches. Standard roll holders generally are designed for these roll sizes and are generally only able to hold only 1 roll.

Therefore, in one embodiment, the rolled paper products of the present invention have an L that allows for more than 1 roll to be held on a single standard roll holder that are designed to hold rolls with a Length of from about 8 inches to about 12 inches. In an embodiment herein, the rolled paper product L is from about 1 inch to about 6 inches, or from about 2 inches to about 6 inches, or from about 2 inches to about 3 inches, or from about 1¼ inches to about 3¾ inches or from about 1⅓ inches to about 2⅔ inches. In another embodiment, the present invention relates to a display assembly, wherein the sum of the Length of two or more individual rolls of rolled paper products is less than or equivalent to about 8 inches, about 9 inches, about 10 inches or about 11 inches.

The present invention furthermore comprises packages of rolled paper products which may comprise combinations of two or more rolled paper products having different lengths. In one embodiment, each rolled product has a length of from about 1¼ inches to about 2 7/4 inches, or about 2 inches to about 3¾ inches, or about 1¼ inches to about 2⅔ inches. The present invention provides a display assembly of a plurality of sizes of rolled paper products to enable a consumer to house a plurality of different rolls, for example with different product benefits or qualities, on existing or standard size roll holders and dispensers.

In another embodiment, the plurality of rolled paper products may embody different fibrous structures having different product qualities or benefits such as caliper, strength, absorbency, bulk, thickness, softness, densities, basis weights, etc.

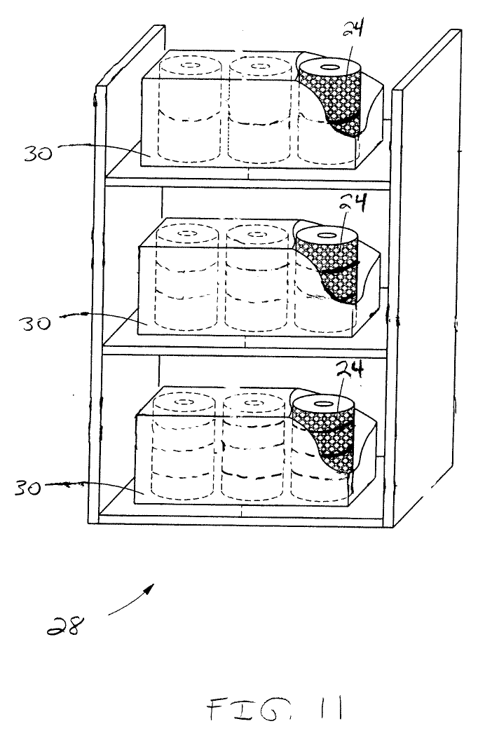

FIG. 11 illustrates an example of a display assembly 28 housing a plurality of rolled paper products 24, which may be paper towels, comprising a plurality of the implements 10 shown in FIG. 9. The display assembly comprises a plurality of rolled paper products 24 comprising packaging or a package 30. The packaging 30 comprises a plurality of rolled paper products with the same or with different Lengths, L, of from about 1 inch to about 6 inches.

In an embodiment the rolled paper products further comprise packaging, each packaging housing a plurality of rolled paper products, such that the sum of the lengths of each product in a package is from about 5 inches to about 12 inches or about 8 inches to about 11 inches.

FIG. 12 shows an exemplary embodiment of the present invention, wherein three rolled products 24 are provided on a holder 99. In FIG. 12, each rolled product has a length of about 1⅓ inches or the holder may house two rolled products that have a length of about 1½ inches. In yet another embodiment, the holder 99 may house two rolls wherein one roll has a length of about 1⅓ inches and another roll has a length of about 2⅔ inches.

The implement of the present invention may include visual and/or physical characteristics. In one embodiment, the implement include visual cues such as embossments, print, texture, and the like, that is phased on the implement in the machine direction and/or cross machine direction. For example, a visual cue may be phased such that the visual cue only is present on the first and/or second flaps and not on the body. In another example, the visual cue may be present on the body but not on one or both of the flaps. In yet another example, the visual cue may be present on first and/or second flaps and also on the body.

The absorbent paper product implement of the present invention may include physical characteristics that differ (visually and/or quantitatively) between the first and second flaps and/or between the first and/or second flaps and the body. For example, the first and/or second flaps may have a caliper that is greater than and/or less than the caliper of the body. In another example, the first flap may have a caliper that is greater than or less than the caliper of the second flap. In yet another example, the first flap and the body may have calipers that are greater than the caliper of the second flap.

The absorbent paper product implement of the present invention may include one surface that is not exposed to the user of the implement. For example, the wire side of the fibrous structure making up the implement may be configured to be on the “inside” of the implement and/or on the “outside” of the implement depending on the desired product. In addition, embossments may be configured to be present on the “inside” surface of the implement and/or on the “outside” surface of the implement depending on the desired product.

The absorbent paper product implement of the present invention may comprise two or more plies of fibrous structures. In such multi-ply fibrous structure implements, one of the plies may be present on the “inside” of the implement. In other words, one of the plies may not be exposed to the user of the implement. In one example, at least one of the two or more plies in a multi-ply fibrous structure implement may have at least one property that is different from at least one other ply in the multi-ply fibrous structure implement. In another example, the multi-ply fibrous structure implement may comprise a ply of through-air-dried fibrous structure and a ply of conventional fibrous structure wherein the implement is configured such that the conventional fibrous structure is not exposed to a user of the implement.

The absorbent paper product implement of the present invention may comprise a layered fibrous structure. For example, the layered fibrous structure may comprise a layer comprising one composition of pulp and a second layer comprising a different composition of pulp. The implement can be configured such that a portion of both of the pulp compositions are exposed to a user of the implement. For example the hardwood pulp layer may be exposed to a user of the implement with a smaller portion of the softwood pulp (such as in the body) being exposed to the user.

The fibrous structure used to form the implement of the present invention may exhibit a caliper, before folding, of at least 0.0254 cm (0.010 inches).

The implement of the present invention may comprise portions of the fibrous structure that have been treated with a chemical agent and/or portions of the fibrous structure that have been mechanically altered and/or portions of the fibrous structure that have received additional materials such as additional pulp fibers, and/or additional synthetic fibers and/or material. Such fibrous structures can be treated to deliver various functions (such as cleaning capability, softness, flexibility, absorbency, water resistance, etc.) from different portions of the implement of the present invention

Thus, the present invention may also provide a display assembly comprising a plurality of folded absorbent paper product implements wherein at least two or more folded absorbent paper product implements have different functions, and that arrangement of the implements in the package may be customized to fit the consumer's specific needs.

Providing a folded paper product that is in roll form is described in U.S. Pat. No. 3,986,479 and WO 98/37794. An exemplary method of making a folded fibrous structure can be achieved by the following. A supply roll of a web of fibrous structure is unwound by driving the circumferential surface, end face surfaces, core, or any combination thereof. The unwinding speed is controlled to achieve a target web speed, relative speed to downstream operations, or web tension. The web is then embossed, if desired, by passing the web between two cooperating rolls, an example being a steel pattern roll loaded against a rubber covered roll, wherein at least one of the rolls imparts a texture or pattern into the web. The embossing means may be configured to emboss only cross machine portions of the web. The resulting longitudinal embossed portions of the web may be aligned in the cross machine with subsequent web transformations. After embossing, additional indicia such as ink may be applied or printed to the web using flexographic, ink jet, or any other indicia imparting means known to one skilled in the art. The web is then separated into at least two longitudinal web strips by linear or non-linear shear slitting, linear or non-linear score slitting, linear or non-linear die cutting, linear or non-linear water jet cutting, linear or non-linear laser cutting, or any other suitable means known in the art. The web strips (e.g. unfolded implements) are then folded using folding boards, turn bars, or any other devices known in the art, to create a “C” or “Z” fold configuration in which at least one portion of at least one web strip is deformed in the transverse direction to produce at least one flap (e.g. a first flap and a second flap) which overlies the remaining portion (e.g., the body) of the web strip. Flaps which include non-linear edges may be oriented such that they form a complementary pattern once the edges are positioned in a proximate configuration. The folded web strips are then passed over a turn bar known to one of skill in the art and redirected to flow in a direction generally perpendicular to the original direction of web travel. Turn bars for each web strip may be positioned in different machine direction locations to reorient the web strips such that, after being redirected, they may be juxtaposed to one another for more efficient winding. Transverse zones of weakness (e.g. perforations) may then be imparted to the folded web strips to enable easier dispensing by the user. Said embossing, indicia addition, slitting, folding, and imparting of transverse zones of weakness transformations may be phased to one another in the machine direction or the cross machine direction or both. The web strips are then rewound into a rolled product, either on a core or in a coreless configuration. The winding operation may control the rotational velocity of the core, the surface speed of the winding product's circumferential surface, or any combination thereof. The wound rolls are then transferred to other operations for wrapping, packing, and the like.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A display assembly comprising:
a plurality of rolled paper products comprising:
a plurality of folded implements convolutely wound about a core or a void area, capable of being dispensed from the rolled paper product, comprising a fibrous structure having a first flap with a first edge; a second flap with a second edge; and a body, between the first flap and the second flap, the body having a first surface and a second surface;
wherein the first flap and the second flap are folded against and overlap either the first surface or the second surface of the body.

2. The display assembly of claim 1 wherein two or more of the plurality of rolled paper products have different product qualities.

3. The display assembly of claim 1 wherein the rolled paper product has a length from about 1 inch to about 6 inches.

4. The display assembly of claim 3 wherein the rolled paper product has a length from about 2 inches to about 3 inches.

5. The product of claim 3 wherein the rolled paper product has a length from about 1¼ inches to about 2⅔ inches.

6. The display assembly of claim 3 wherein the rolled paper products further comprise packages, each package housing a plurality of rolled paper products, such that the sum of the lengths of each product in a package is from about 5 inches to about 12 inches.

7. The display assembly of claim 6 wherein the sum of the lengths of each product in a package is from about 8 inches to about 11 inches.

8. The display assembly of claim 1 wherein the first flap and the second flap overlap less that 100% of the first surface or the second surface of the body.

9. The product of claim 1 wherein the first edge is non-linear.

10. The product of claim 1 wherein the second edge is non-linear.

11. The product of claim 1 wherein the first edge and second edge are complementary.

12. The product of claim 1 wherein the first edge and second edge are symmetrical.
